(19) United States
(12) Patent Application Publication
(10) Pub. No.: US 2011/0179261 A1
(43) Pub. Date: Jul. 21, 2011

(54) METHOD FOR CONTROLLING NETWORK CONTROLLER, NON-TRANSITORY COMPUTER READABLE RECORDING MEDIUM, AND INFORMATION PROCESSING APPARATUS

(75) Inventor: Masazumi TACHIBANA, Kawasaki (JP)

(73) Assignee: FUJITSU LIMITED, Kawasaki-shi (JP)

(21) Appl. No.: 12/987,551

(22) Filed: Jan. 10, 2011

(30) Foreign Application Priority Data
Jan. 19, 2010 (JP) 2010-009449

(51) Int. Cl. G06F 9/00

(52) U.S. Cl. 713/2

(57) ABSTRACT

A method for controlling a network controller, including: preferentially booting a network controller assignment controlling driver before at least one of a network controller controlling driver for EFI and a network controller controlling driver for legacy BIOS initializes the network controller, the network controller assignment controlling driver deciding whether to operate the network controller by either of the EFI or the legacy BIOS, based on preset setting data of the network controller; and exclusively acquiring a driver providing a protocol used for initialization of the network controller by the network controller assignment controlling driver when the setting data of the network controller is an instruction to initialize the network controller for the legacy BIOS.

### CROSS-REFERENCE TO RELATED APPLICATION

This application is based upon and claims the benefit of priority of the prior Japanese Patent Application No. 2010-009449, filed on Jan. 19, 2010, the entire contents of which are incorporated herein by reference.

### FIELD

A certain aspect of the embodiments discussed herein is related to a method for controlling a network controller, a non-transitory computer readable recording medium, and an information processing apparatus.

### BACKGROUND

Each of a personal computer and a server according to conventional architecture of Intel Corporation includes initialization and diagnosis functions of a system, and an OS (Operating System) boot function by firmware that is called BIOS (Basic Input Output System). However, in recent years, firmware that is called EFI (Extensible Firmware Interface) which has enhanced the BIOS is widespread. For example, a document 1 (Japanese Laid-Open Patent Application No. 2005-182491) is known as the construction of a system using the EFI.

To boot (start up) an OS with the EFI, the OS corresponding to the EFI is required. For example, Windows server 2008 corresponding to the EFI cannot be booted with the conventional BIOS (hereinafter referred to as “the legacy BIOS”). On the contrary, Windows server 2003 and Red Hat Linux 5 (hereinafter referred to as “the legacy OSs”) which do not correspond to the EFI cannot be booted with the EFI. To support these conventional legacy OSs widely, a module (hereinafter referred to as “the CSM (Compatibility Support Module)”) that has a BIOS compatibility function to be installed in the EFI is developed.

Incidentally, a computer system of the EFI base which has installed the conventional CSM includes only a function for enabling or disabling a particular LAN (Local Area Network) controller, and a function for selecting whether to control the entire enabled LAN controller by the EFI or the legacy BIOS. Consequently, when the EFI fails in the network boot, and the legacy BIOS executes the network boot, for example, a device executing the network boot is required to execute reboot, setting change, and reboot.

### SUMMARY

According to an aspect of the present invention, there is provided a method for controlling a network controller, including: preferentially booting a network controller assignment controlling driver before at least one of a network controller controlling driver for EFI and a network controller controlling driver for legacy BIOS initializes the network controller, the network controller assignment controlling driver deciding whether to operate the network controller by either of the EFI or the legacy BIOS, based on preset setting data of the network controller; and exclusively acquiring a driver providing a protocol used for initialization of the network controller by the network controller assignment controlling driver when the setting data of the network controller is an instruction to initialize the network controller for the legacy BIOS.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a computer system of an EFI (Extensible Firmware Interface) base which has installed a CSM (Compatibility Support Module);

FIG. 2 is a flowchart illustrating processes executed with a network boot executing server at the time of failure of network boot;

FIG. 3 is a diagram illustrating schematic construction of the network boot executing server;

FIG. 4 is a diagram illustrating a connection process of the EFI;

FIG. 5 is a diagram illustrating schematic construction of an information processing apparatus;

FIG. 6 is an explanatory diagram illustrating the operation of the information processing apparatus;

FIG. 7 is an explanatory diagram illustrating the operation of the information processing apparatus;

FIG. 8 is an explanatory diagram illustrating the operation of the information processing apparatus;

FIG. 9 is an explanatory diagram illustrating the operation of the information processing apparatus; and

FIG. 10 is a flowchart illustrating the connection process executed by a LAN controller assignment controlling driver.

### DESCRIPTION OF EMBODIMENTS

A description will now be given, with reference to the accompanying drawings, of an exemplary embodiment.

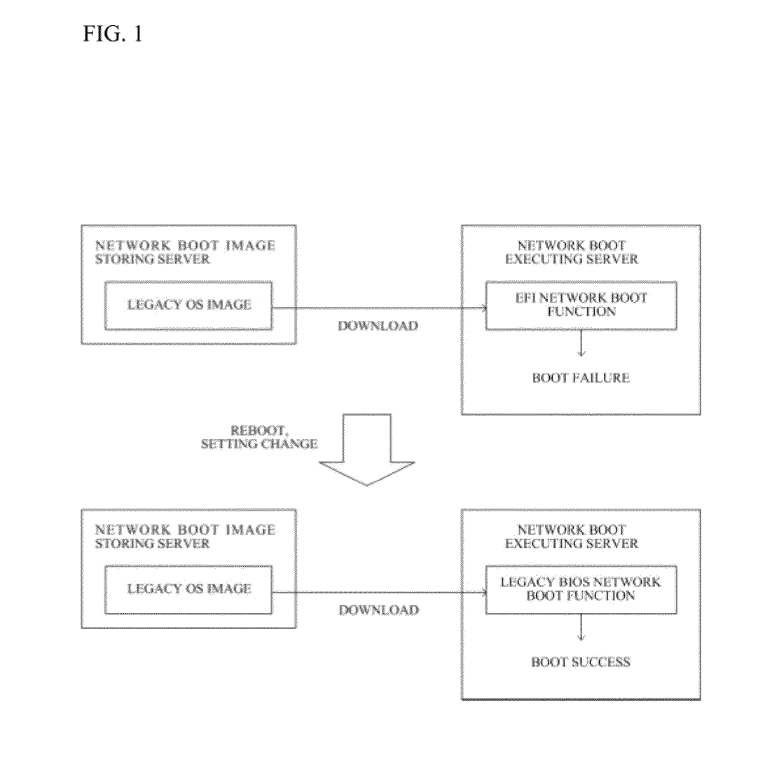

First, a description will now be given, with reference to FIGS. 1 to 4, of a reference example.

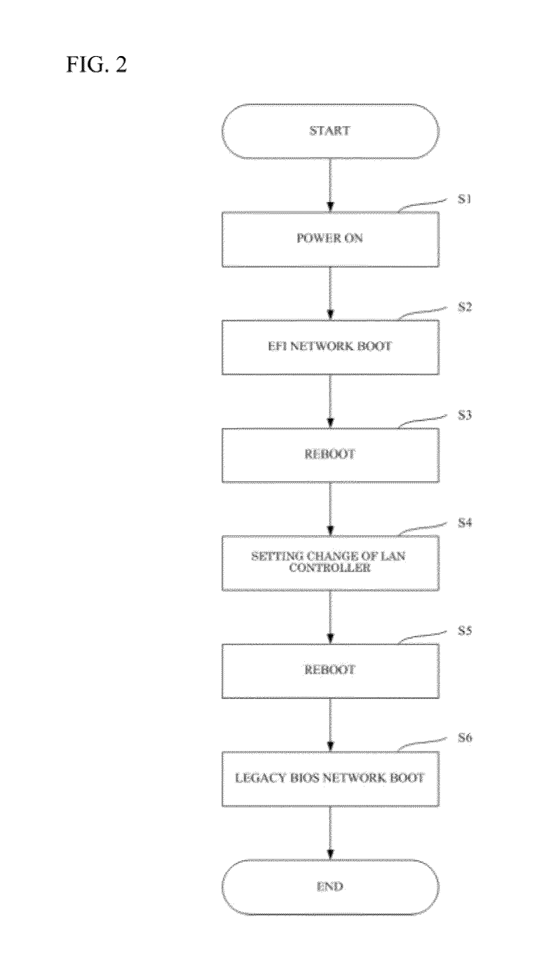

FIG. 1 illustrates a computer system of an EFI (Extensible Firmware Interface) base which has installed a CSM (Compatibility Support Module). FIG. 2 illustrates processes executed with a network boot executing server at the time of failure of network boot. The computer system of FIG. 1 includes a network boot image storing server and a network boot executing server. In the network boot image storing server, an image of the legacy OS is stored. The image of the legacy OS is an image that cannot be booted with a network boot function of the EFI. It is assumed that the network boot executing server executes the network boot in the order of EFI network boot and legacy network boot.

In FIG. 2, when the network boot executing server is powered on (step S1), the network boot executing server boots the image of the legacy OS with the network boot function of the EFI (step S2). However, the network boot executing server fails in the boot. Consequently, the network boot executing server executes reboot (step S3). A user changes setting of a LAN controller of the network boot executing server from setting for the EFI network boot to setting for legacy network boot (step S4). Then, the network boot executing server executes reboot (step S5). Thereby, the network boot executing server boots the image of the legacy OS with the network boot function of the legacy BIOS (step S6). Thus, the reason why the network boot executing server executes the reboot, the setting change, and the reboot is that a LAN controller controlling driver for legacy BIOS and a LAN controller controlling driver for EFI separately exist, and there is a case where the respective drivers control a single LAN controller at the same time.

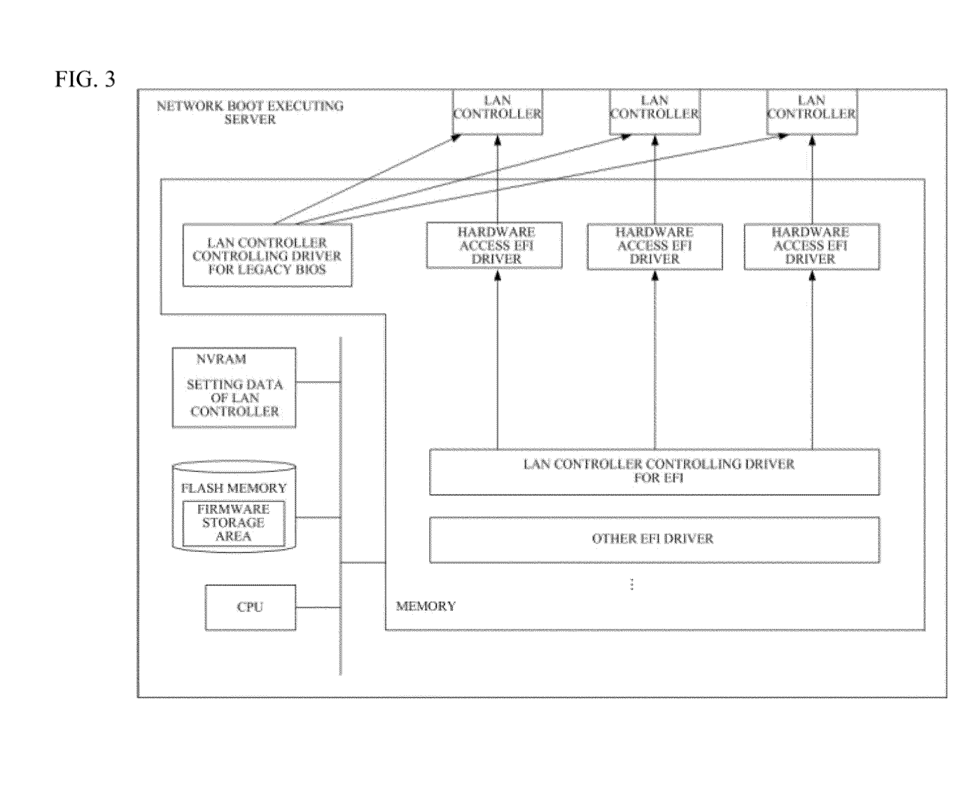

FIG. 3 is a diagram illustrating schematic construction of the network boot executing server. In FIG. 3, the network boot executing server includes a CPU (Central Processing Unit), a flash memory, a NVRAM (Non Volatile Random Access Memory), a memory, and LAN controllers. In the memory, the LAN controller controlling driver for legacy BIOS, hardware access EFI drivers, the LAN controller controlling driver for EFI, and other EFI driver are expanded.

The LAN controller controlling driver for EFI controls the LAN controllers via the hardware access EFI drivers. In the EFI, when any LAN controller controlling driver for EFI sets a hardware access EFI driver to a controlled object, another LAN controller controlling driver for EFI includes a mechanism (i.e., a connection process described later) that cannot set the same hardware access EFI driver to the controlled object. When the LAN controller controlling driver for EFI initializes the LAN controller, hardware setting and setting of the EFI suitable for the operation by the EFI are executed. Similarly, when the LAN controller controlling driver for legacy BIOS initializes the LAN controller, hardware setting suitable for the operation by the legacy BIOS is executed. Then, the LAN controller controlling driver for legacy BIOS and the LAN controller controlling driver for EFI do not recognize each other, and initialize the LAN controller. Consequently, when the LAN controller controlling driver for EFI initializes the LAN controller, and then the LAN controller controlling driver for legacy BIOS initializes the same LAN controller, for example, hardware setting previously set for the EFI cannot operate. Therefore, there is a possibility that the system included in the network boot executing server becomes unstable, and this causes a state where the operation of the network boot executing server cannot be secured.

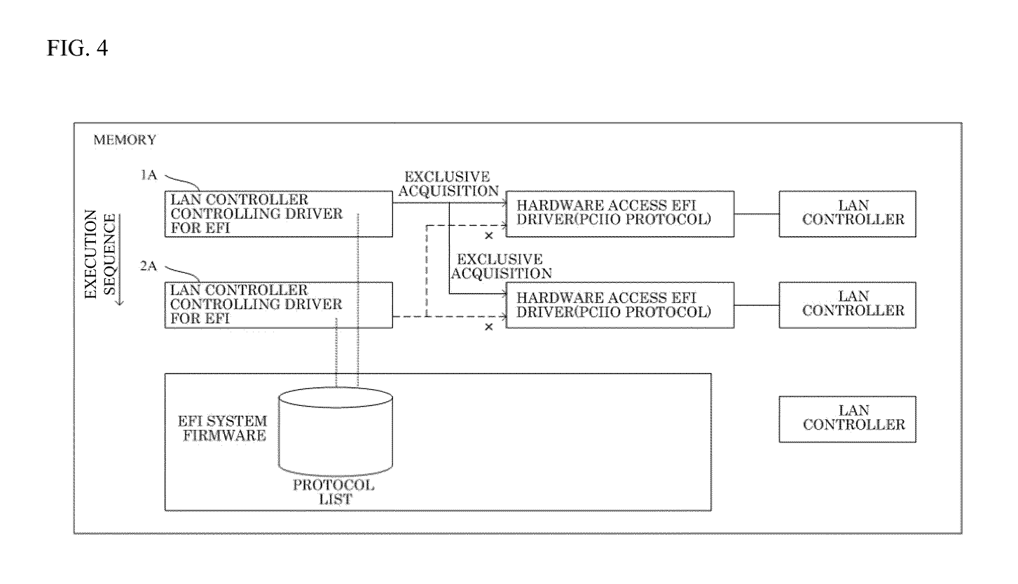

FIG. 4 is a diagram illustrating the connection process of the EFI. The connection process is a process in which an EFI system firmware connects controls between drivers (e.g. the LAN controller controlling driver for EFI, and the hardware access EFI driver (PciIo protocol)) by using a function “Connect Controller” of the EFI. The EFI has the connection process as a basic function.

In FIG. 4, when LAN controller controlling drivers for EFI are expanded in the memory, the LAN controller controlling drivers for EFI are stored into a protocol list of the EFI system firmware. In the connection process, the EFI system firmware inspects whether each LAN controller controlling driver for EFI can control each LAN controller. When the LAN controller controlling driver for EFI can control the LAN controller, the LAN controller controlling driver for EFI exclusively acquires a hardware access EFI driver (PciIo protocol) corresponding to the LAN controller. Thereby, another LAN controller controlling driver for EFI cannot sets the same hardware access EFI driver (PciIo protocol) to the controlled object. It is assumed that this state where the hardware access EFI driver (PciIo protocol) is exclusively acquired is called “connection completion”. It should be noted that the function of the EFI can control the order of the LAN controller controlling drivers for EFI performing the connection process. In FIG. 4, the EFI system firmware inspects whether the LAN controller controlling driver for EFI 1A is set above the LAN controller controlling driver for EFI 2A, and can be connected to the LAN controller.

Usually, the EFI has a mechanism that two or more drivers cannot redundantly control a single hardware by the connection process. However, the LAN controller controlling driver for legacy BIOS directly controls the LAN controller without using the functions of the EFI. Therefore, the LAN controller controlling driver for EFI may redundantly initialize the LAN controller which the LAN controller controlling driver for legacy BIOS has already initialized. On the other hand, the LAN controller controlling driver for EFI initializes only the LAN controller required for the boot of the OS. Therefore, when the LAN controller controlling driver for legacy BIOS initializes another LAN controller, the drivers do not redundantly initialize the single LAN controller. As a result, each LAN controller can normally operate.

However, in EFI, a setup menu that displays a list of devices capable of booting the OSs exists in the network boot executing server. Therefore, to create the list of devices capable of booting the OSs, the EFI system firmware needs to connect the LAN controller controlling driver for EFI to all of the LAN controllers. This is called “Connect-All”. In the Connect-All, the LAN controller controlling driver for EFI sets all of the LAN controllers to the controlled objects. When the LAN controller controlling driver for legacy BIOS initializes a certain LAN controller after or before the Connect-All is executed, the LAN controller is initialized twice. Therefore, there is a possibility that the system included in the network boot executing server becomes unstable, and this causes a state where the operation of the network boot executing server cannot be secured. Further, in EFI, a user can manually cause the network boot executing server to execute the Connect-All from an interface that is called EFI SHELL, and hence it is likely to easily enter a state where the LAN controller is redundantly initialized.

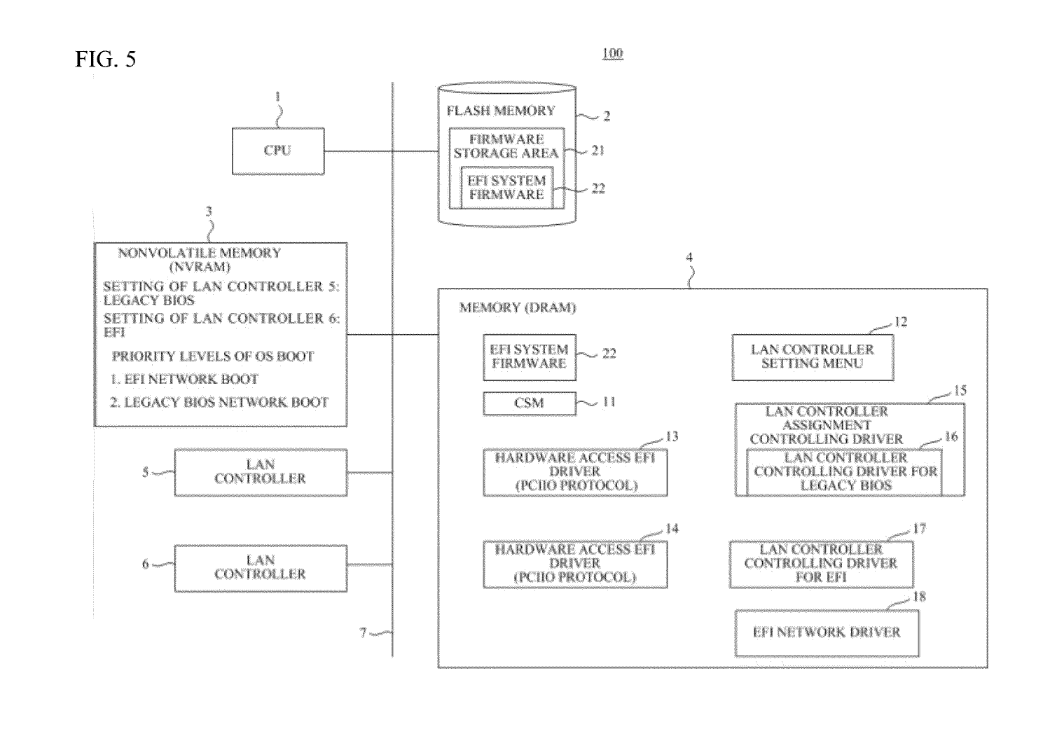

Next, a description will now be given, with reference to FIGS. 5 to 10, of an exemplary embodiment.

FIG. 5 is a diagram illustrating schematic construction of an information processing apparatus according to the present embodiment. An information processing apparatus 100 in FIG. 5 is a computer such as a server or a client, and executes network boot. The network boot is one of methods for starting up or booting an OS (Operating System), and boots the OS by downloading an image of the OS via a network.

The information processing apparatus 100 includes: a CPU 1; a flash memory 2; a nonvolatile memory (NVRAM; Non volatile RAM) 3; a memory (DRAM; Dynamic Random Access Memory) 4; and LAN (Local Area Network) controllers 5 and 6. The CPU 1 is coupled to the flash memory 2, the nonvolatile memory 3, the memory 4, and the LAN controllers 5 and 6 via a bus 7.

The CPU 1 controls the whole operation of the information processing apparatus 100. The flash memory 2 includes a firmware storage area 21. In the firmware storage area 21, an EFI (Extensible Firmware Interface) system firmware 22 is stored. Moreover, the flash memory 2 includes a CSM (Compatibility Support Module) 11, a LAN controller setting menu 12, hardware access EFI drivers (PciIo protocol) 13 and 14, and a LAN controller assignment controlling driver 15. The flash memory 2 further includes a LAN controller controlling driver for legacy BIOS 16, a LAN controller controlling driver for EFI 17, and an EFI network driver 18.

The CSM 11 is a module that has a BIOS compatibility function. The LAN controller setting menu 12 is a menu for setting the LAN controller controlling drivers which uses the LAN controllers 5 and 6. The hardware access EFI drivers (PciIo protocol) 13 and 14 provide protocols used for the initialization of the LAN controllers 5 and 6. The LAN controller assignment controlling driver 15 decides the LAN controller controlling drivers that control the LAN controllers 5 and 6. The LAN controller controlling driver for legacy BIOS 16 initializes the LAN controller by using the legacy BIOS, and controls the LAN controller. The LAN controller controlling driver for EFI 17 initializes the LAN controller by using a PciIo protocol which the hardware access EFI driver provides, and controls the LAN controller. The EFI network driver 18 is a driver for packet communication.

The nonvolatile memory 3 stores setting whether each of the LAN controller 5, 6 is used by the legacy BIOS or the EFI. Moreover, the nonvolatile memory 3 stores setting of priority levels of OS boot. In FIG. 5, as the priority levels of the OS boot, the EFI network boot is first set, and then the legacy BIOS network boot is set. The memory 4 functions as a working area. The LAN controllers 5 and 6 are LAN ports, and are connected to a server storing an OS image for the network boot, via a network, not shown. The information processing apparatus 100 may include one or more LAN controllers, and the number of LAN controllers is not limited to two.

When the information processing apparatus 100 is turned on, the CPU 1 reads out the EFI system firmware 22, and expands the EFI system firmware 22 into the memory 4. The EFI system firmware 22 expands the CSM 11, the LAN controller setting menu 12, the hardware access EFI drivers (PciIo protocol) 13 and 14, the LAN controller assignment controlling driver 15, the LAN controller controlling driver for EFI 17, and the EFI network driver 18 into the memory 4 according to the control of the CPU 1, as shown in FIG. 5. The EFI system firmware 22 expands the hardware access EFI drivers (PciIo protocol) into the memory 4 depending on the number of LAN controllers. The LAN controller assignment controlling driver 15 expands the LAN controller controlling driver for legacy BIOS 16 into the memory 4 if necessary.

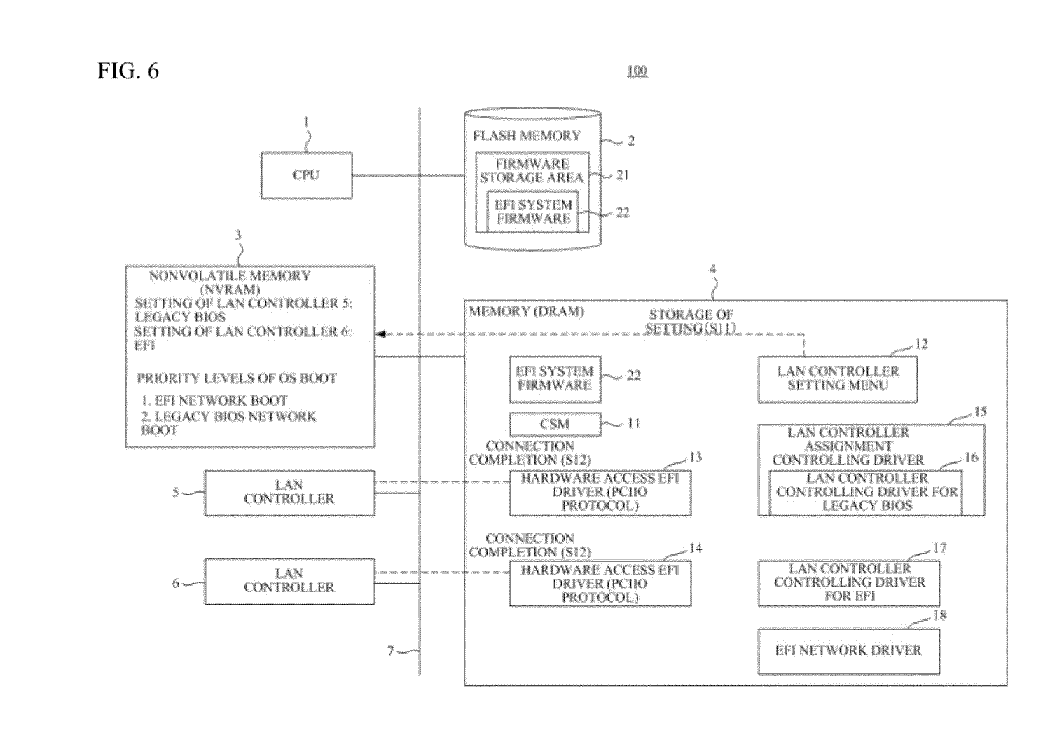

A description will now be given, with reference to FIGS. 6 to 9, of the operation of the information processing apparatus 100, i.e., a setup process, a connection process, and a network boot process executed with the information processing apparatus 100. Here, it is assumed that the EFI system firmware 22, the CSM 11, the LAN controller setting menu 12, and various drivers are expanded into the memory 4.

(Setup process) In FIG. 6, the LAN controller setting menu 12 first stores setting whether to use the LAN controllers 5 and 6 by the legacy BIOS or the EFI, into the nonvolatile memory 3 according to user's instruction (S11). This setting is reflected by the reset of the information processing apparatus 100. Further, the LAN controller setting menu 12 sets the priority levels of the OS boot to the nonvolatile memory 3 according to the user's instruction. In an initialization process on startup of the information processing apparatus 100, the EFI system firmware 22 assigns the hardware access EFI drivers (PciIo protocol) 13 and 14 to the LAN controllers 5 and 6, respectively (S12).

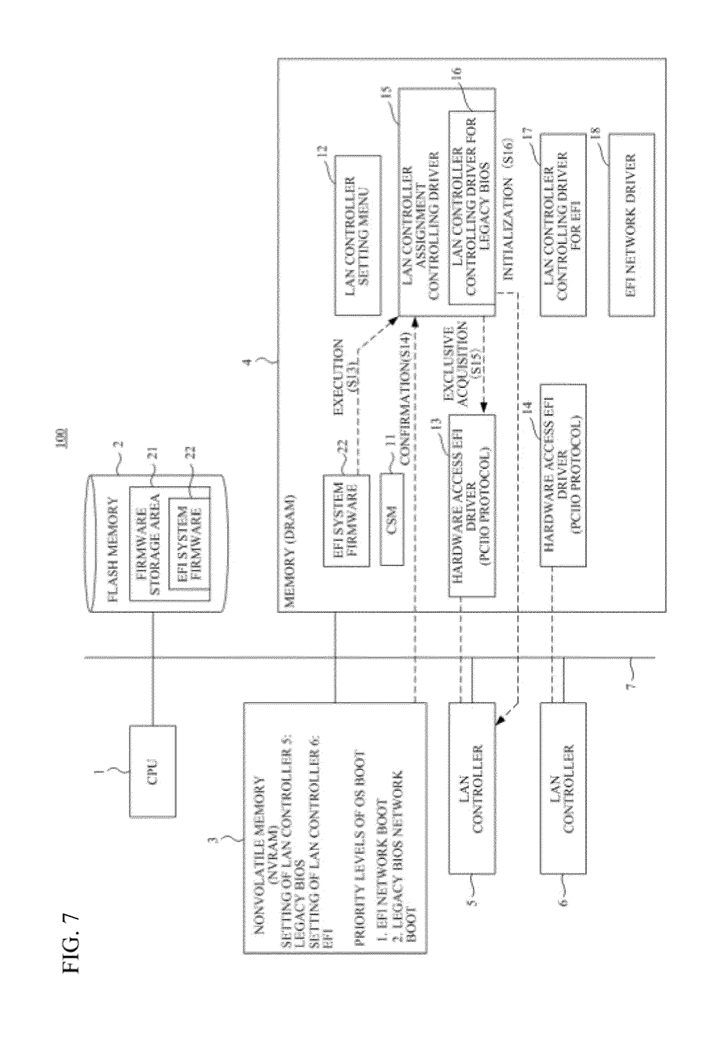

(Connection process to the LAN controller 5) Next, in FIG. 7, the connection process to the LAN controller 5 is executed. Specifically, the EFI system firmware 22 executes the LAN controller assignment controlling driver 15 with highest priority (S13). The LAN controller assignment controlling driver 15 refers to the nonvolatile memory 3, and confirms that the setting of the LAN controller 5 is an instruction for initializing the LAN controller 5 for the legacy BIOS (S14).

The LAN controller assignment controlling driver 15 exclusively acquires the hardware access EFI driver (PciIo protocol) 13 (S15). More specifically, the LAN controller assignment controlling driver 15 specifies an attribute of the hardware access EFI driver (PciIo protocol) 13 by OPEN_BY_DRIVER, specifying an attribute of the driver, which is included in Open Protocol provided beforehand by the function of the EFI, so that the LAN controller assignment controlling driver 15 acquires the hardware access EFI driver (PciIo protocol) 13. Here, exclusively acquiring the hardware access EFI driver (PciIo protocol) 13 means that the hardware access EFI driver (PciIo protocol) 13 is not acquired afterward by another driver such as the LAN controller controlling driver for EFI 17. The LAN controller assignment controlling driver 15 executes the LAN controller controlling driver for legacy BIOS 16. The LAN controller controlling driver for legacy BIOS 16 initializes the LAN controller 5 by using the legacy BIOS (S16). The connection process is terminated.

Then, when the EFI system firmware 22 executes the LAN controller controlling driver for EFI 17, the LAN controller controlling driver for EFI 17 does not acquire the hardware access EFI driver (PciIo protocol) 13. This is because the hardware access EFI driver (PciIo protocol) 13 has been already acquired by the LAN controller assignment controlling driver 15. Therefore, the LAN controller controlling driver for EFI 17 does not set the hardware access EFI driver (PciIo protocol) 13 to the controlled object.

As described above, the LAN controller assignment controlling driver 15 exclusively acquires the hardware access EFI driver (PciIo protocol) 13. However, when the setting in which the LAN controller 6 is used by the legacy BIOS, and the setting in which the LAN controller 5 is used by the EFI are stored into the nonvolatile memory 3, the LAN controller assignment controlling driver 15 exclusively acquires the hardware access EFI driver (PciIo protocol) 14. That is, the LAN controller assignment controlling driver 15 changes the hardware access EFI driver (PciIo protocol) to be acquired depending on the setting of the LAN controllers 5 and 6.

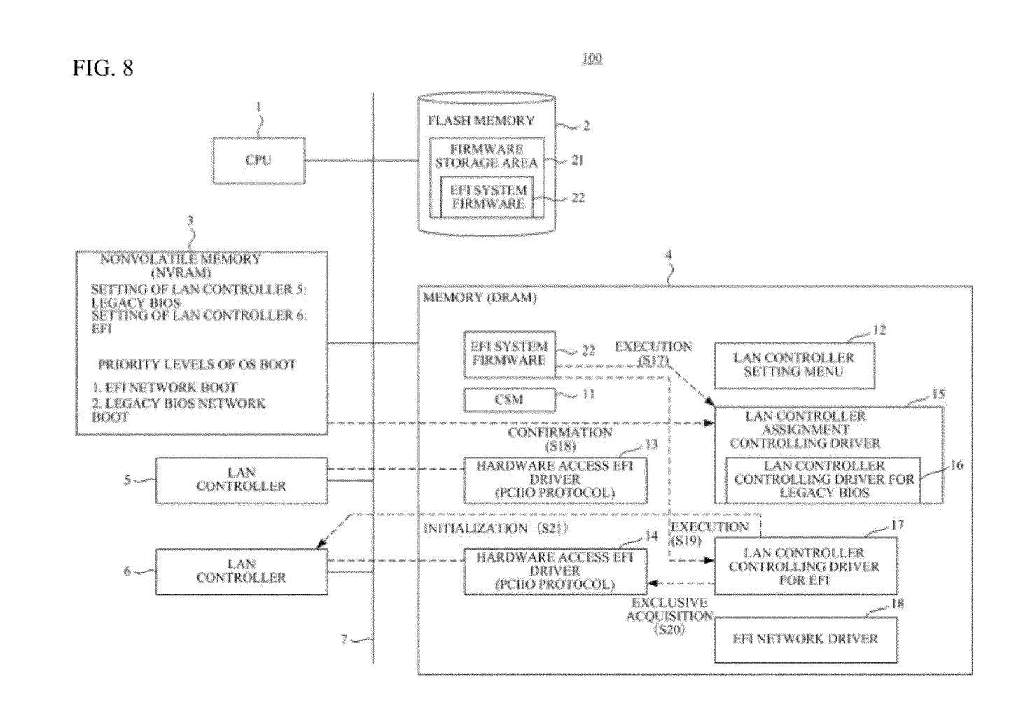

(Connection process to the LAN controller 6) Next, in FIG. 8, the connection process to the LAN controller 6 is executed. Specifically, the EFI system firmware 22 executes the LAN controller assignment controlling driver 15 with highest priority (S17).

The LAN controller assignment controlling driver 15 refers to the nonvolatile memory 3, and confirms that the setting of the LAN controller 6 is an instruction for initializing the LAN controller 6 for the EFI (S18). Since the setting of the LAN controller 6 is not the instruction for initializing the LAN controller 6 for the legacy BIOS, the LAN controller assignment controlling driver 15 does not exclusively acquire the hardware access EFI driver (PciIo protocol) 14. The connection process is terminated.

Next, the EFI system firmware 22 executes the LAN controller controlling driver for EFI 17 (S19). The LAN controller controlling driver for EFI 17 specifies an attribute of the hardware access EFI driver (PciIo protocol) 14 by OPEN_BY_DRIVER, specifying an attribute of the driver, which is included in Open Protocol provided beforehand by the function of the EFI, so that the LAN controller controlling driver for EFI 17 exclusively acquires the hardware access EFI driver (PciIo protocol) 14 (S20). The LAN controller controlling driver for EFI 17 initializes the LAN controller 6 by using the PciIo protocol (S21). Here, when the setting in which the LAN controller 6 is used by the legacy BIOS, and the setting in which the LAN controller 5 is used by the EFI are stored into the nonvolatile memory 3, the LAN controller controlling driver for EFI 17 exclusively acquires the hardware access EFI driver (PciIo protocol) 13.

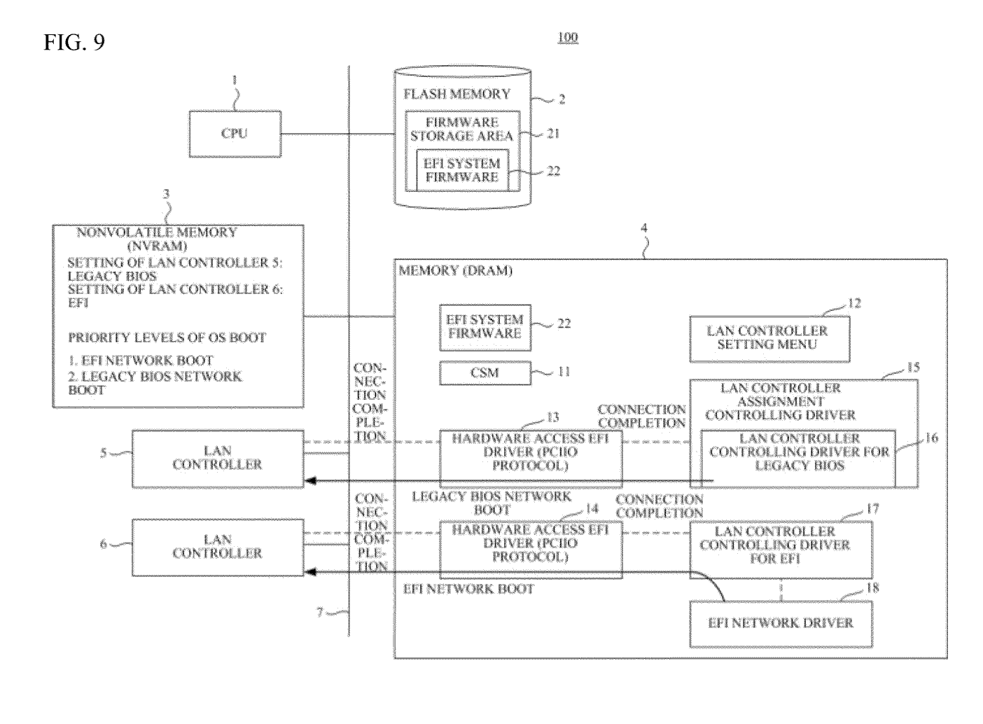

(Network boot process) In FIG. 9, when the connection processes to the LAN controllers 5 and 6 are terminated, the EFI system firmware 22 switches the LAN controller initialized by the LAN controller controlling driver for EFI 17 and the LAN controller initialized by the LAN controller controlling driver for legacy BIOS 16 according to the priority levels of the OS boot in the nonvolatile memory 3, and executes the network boot. In this case, the LAN controller controlling driver for legacy BIOS 16 and the LAN controller controlling driver for EFI 17 do not redundantly initialize the single LAN controller, and hence the reboot and/or the setting change of the information processing apparatus 100 are not required.

In the legacy BIOS network boot, the CSM 11 acquires a BEV (Boot Entry Vector) entry from a PnP (Plug and Play) extension header that can be acquired when the LAN controller controlling driver for legacy BIOS 16 is initialized, and executes the entry point of the BEV entry. Thereby, the EFI system firmware 22 executes the network boot via the LAN controller 5 initialized by the LAN controller controlling driver for legacy BIOS 16.

In the EFI network boot, the EFI network driver 18 loads the OS image for the network boot from the server storing OS images, and executes the entry point of the OS image. Thereby, the EFI system firmware 22 executes the network boot via the LAN controller 6 initialized by the LAN controller controlling driver for EFI 17.

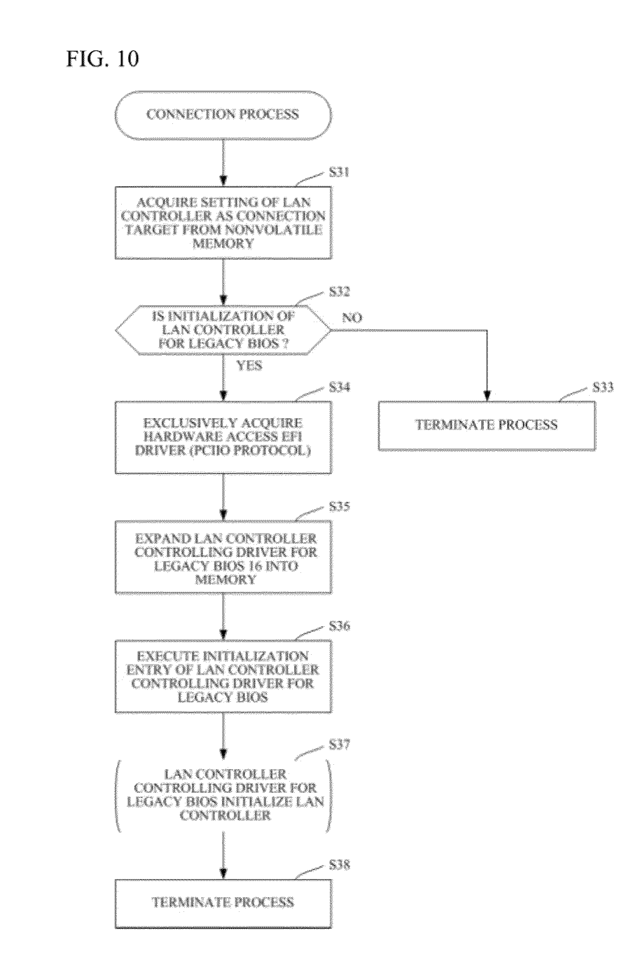

FIG. 10 is a flowchart illustrating the connection process executed by the LAN controller assignment controlling driver 15.

The LAN controller assignment controlling driver 15 acquires setting of the LAN controller as a connection target from the nonvolatile memory 3 (S31). The LAN controller assignment controlling driver 15 judges whether the acquired setting of the LAN controller as the connection target is an instruction to initialize the LAN controller for the legacy BIOS (S32). When the acquired setting of the LAN controller as the connection target is not the instruction to initialize the LAN controller for the legacy BIOS (NO in S32), the LAN controller assignment controlling driver 15 terminates the connection process (S33). When the acquired setting of the LAN controller as the connection target is the instruction to initialize the LAN controller for the legacy BIOS (YES in S32), the LAN controller assignment controlling driver 15 exclusively acquires the hardware access EFI driver (PciIo protocol) assigned to the LAN controller as the connection target (S34).

Next, the LAN controller assignment controlling driver 15 expands the LAN controller controlling driver for legacy BIOS 16 into the memory 4 (S35). The LAN controller assignment controlling driver 15 executes initialization entry of the LAN controller controlling driver for legacy BIOS 16 (S36). By the procedure of S36, the LAN controller controlling driver for legacy BIOS 16 initializes the LAN controller as the connection target (S37). Then, the LAN controller assignment controlling driver 15 terminates the connection process (S38).

As described above, according to the present embodiment, when the LAN controller 5 is initialized for the legacy BIOS, the LAN controller assignment controlling driver 15, which preferentially boots, exclusively acquires the hardware access EFI driver (PciIo protocol) 13 that provides a protocol used for the initialization of the LAN controller 5, and hence the LAN controller controlling driver for EFI 17 cannot acquire the hardware access EFI driver (PciIo protocol) 13. Therefore, the LAN controller controlling driver for legacy BIOS 16 and the LAN controller controlling driver for EFI 17 can be prevented from redundantly initializing the single LAN controller. Moreover, according to the present embodiment, even when the LAN controller controlling driver for legacy BIOS 16 and the LAN controller controlling driver for EFI 17 exist on the memory 4 together, the EFI network boot and the legacy BIOS network boot can be switched without the reboot and/or the setting change of the information processing apparatus 100.

A computer may execute a software program for realizing the functions of the information processing apparatus 100. In this manner, the same effects as those of the above described embodiment can also be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method for controlling a network controller, comprising:
preferentially booting a network controller assignment controlling driver before at least one of a network controller controlling driver for EFI and a network controller controlling driver for legacy BIOS initializes the network controller, the network controller assignment controlling driver deciding whether to operate the network controller by either of the EFI or the legacy BIOS, based on preset setting data of the network controller; and
exclusively acquiring a driver providing a protocol used for initialization of the network controller by the network controller assignment controlling driver when the setting data of the network controller is an instruction to initialize the network controller for the legacy BIOS.

2. The method for controlling a network controller according to claim 1, wherein:
when the setting data of the network controller is an instruction to initialize the network controller for the EFI, the network controller controlling driver for EFI acquires the driver providing the protocol, and initializes the network controller,
when the setting data of the network controller is the instruction to initialize the network controller for the legacy BIOS, the network controller controlling driver for legacy BIOS initializes the network controller, and
an EFI system firmware switches the network controller initialized by the network controller controlling driver for EFI and the network controller initialized by the network controller controlling driver for legacy BIOS according to preset priority levels of boot, and executes network boot.

3. A non-transitory computer readable recording medium causing a computer to execute a process for controlling a network controller, the process comprising:
preferentially booting a network controller assignment controlling driver before at least one of a network controller controlling driver for EFI and a network controller controlling driver for legacy BIOS initializes the network controller, the network controller assignment controlling driver deciding whether to operate the network controller by either of the EFI or the legacy BIOS, based on preset setting data of the network controller; and
exclusively acquiring a driver providing a protocol used for initialization of the network controller by the network controller assignment controlling driver when the setting data of the network controller is an instruction to initialize the network controller for the legacy BIOS.

4. The non-transitory computer readable recording medium according to claim 3, wherein:
when the setting data of the network controller is an instruction to initialize the network controller for the EFI, the network controller controlling driver for EFI acquires the driver providing the protocol, and initializes the network controller,
when the setting data of the network controller is the instruction to initialize the network controller for the legacy BIOS, the network controller controlling driver for legacy BIOS initializes the network controller, and
an EFI system firmware switches the network controller initialized by the network controller controlling driver for EFI and the network controller initialized by the network controller controlling driver for legacy BIOS according to preset priority levels of boot, and executes network boot.

5. An information processing apparatus, comprising:
a network controller assignment controlling driver that is preferentially booted before at least one of a network controller controlling driver for EFI and a network controller controlling driver for legacy BIOS initializes the network controller, and that decides whether to operate the network controller by either of the EFI or the legacy BIOS, based on preset setting data of the network controller;
wherein the network controller assignment controlling driver exclusively acquires a driver providing a protocol used for initialization of the network controller when the setting data of the network controller is an instruction to initialize the network controller for the legacy BIOS.

6. The information processing apparatus according to claim 5, wherein:
when the setting data of the network controller is an instruction to initialize the network controller for the EFI, the network controller controlling driver for EFI acquires the driver providing the protocol, and initializes the network controller,
when the setting data of the network controller is the instruction to initialize the network controller for the legacy BIOS, the network controller controlling driver for legacy BIOS initializes the network controller, and
an EFI system firmware switches the network controller initialized by the network controller controlling driver for EFI and the network controller initialized by the network controller controlling driver for legacy BIOS according to preset priority levels of boot, and executes network boot.
